(19) United States
(12) Patent Application Publication
(10) Pub. No.: US 2026/0112050 A1
(43) Pub. Date: Apr. 23, 2026

(54) INFORMATION PROCESSING DEVICE, INFORMATION PROCESSING METHOD, AND PROGRAM

(71) Applicant: SONY GROUP CORPORATION, Tokyo (JP)

(72) Inventors: Takaaki KATO, Kanagawa (JP); Shunichi HOMMA, Saitama (JP); Yuki TAKEDA, Kanagawa (JP); Ryosuke MURATA, Kanagawa (JP); Fujio ARAI, Tokyo (JP); Manabu KAWASHIMA, Tokyo (JP)

(73) Assignee: SONY GROUP CORPORATION, Tokyo (JP)

(21) Appl. No.: 19/111,311

(22) PCT Filed: Sep. 12, 2023
(86) PCT No.: PCT/JP2023/033141

§ 371 Date: Mar. 13, 2025

(30) Foreign Application Priority Data
Sep. 30, 2022 (JP) 2022-158522

(51) Int. Cl. G06T 7/73; G06T 19/00

(52) U.S. Cl. CPC G06T 7/73; G06T 19/00

(57) ABSTRACT

There is provided an information processing device, an information processing method, and a program capable of providing an imaging position and an imaging direction in both a case where estimation is successful and a case where estimation fails, in a case where the imaging position and the imaging direction are estimated. A reception unit acquires an evaluation image and imaging information for evaluation. An estimation unit estimates the imaging position and the imaging direction of the evaluation image by performing matching between the feature point of a 3D map and the feature point of the evaluation image. An evaluation map creation unit creates an evaluation map in which success-or-failure related information regarding whether or not estimation has been successful is registered in association with the imaging position and the imaging direction of the evaluation image. An evaluation map update unit updates the success-or-failure related information corresponding to the estimated imaging position and imaging direction in a case where the estimation is successful, and updates the success-or-failure related information corresponding to the imaging position and imaging direction indicated by the imaging information for evaluation in a case where the estimation fails. The present technology can be applied to, for example, a server or the like.

### TECHNICAL FIELD

The present technology relates to an information processing device, an information processing method, and a program, and more particularly, to an information processing device, an information processing method, and a program capable of providing an imaging position and an imaging direction in both a case where estimation is successful and a case where estimation fails, in a case where the imaging position and the imaging direction are estimated.

### BACKGROUND ART

In recent years, a technology such as a visual positioning system (VPS) that estimates (localizes) an imaging position and an imaging direction from a captured image using a 3D map has been developed. The creation of the 3D map can be realized, for example, by executing open source called COLMAP (see, for example, Non-Patent Document 1).

### CITATION LIST

### Non-Patent Document

Non-Patent Document 1: Johannes L. Schonberger, Jan-Michael Frahm, “Structure-from-Motion Revisited”, 2016 IEEE Conference on Computer Vision and Pattern Recognition (CVPR), 2016, p. 4104-4113

### SUMMARY OF THE INVENTION

### Problems to be Solved by the Invention

However, it is not considered that a plurality of evaluation observation results of the VPS is integrated and presented to an evaluator in an easy-to-understand manner. Therefore, it is difficult for the evaluator to determine whether or not the 3D map used for the VPS is accurately created.

In a case where the evaluator evaluates the VPS, for example, it is necessary to recognize both the imaging position and the imaging direction for which estimation has been successful and the imaging position and the imaging direction for which estimation has failed. Therefore, in a case where the imaging position and the imaging direction are estimated by the VPS or the like, there is a demand for a method of providing the imaging position and the imaging direction in both a case where the estimation is successful and a case where the estimation fails, but such a demand is not sufficiently met.

The present technology has been made in view of such a situation, and an object thereof is to provide an imaging position and an imaging direction in both a case where estimation is successful and a case where estimation is unsuccessful in a case where the imaging position and the imaging direction are estimated.

### Solutions to Problems

An information processing device or a program according to one aspect of the present technology is an information processing device including: an acquisition unit that acquires an evaluation image captured by an imaging device and imaging information for evaluation that is imaging information indicating an imaging position and an imaging direction of the evaluation image; an estimation unit that estimates the imaging position and the imaging direction of the evaluation image by performing matching between a feature point of a 3D map and a feature point of the evaluation image acquired by the acquisition unit; a creation unit that creates an evaluation map that registers success-or-failure related information related to whether or not the estimation by the estimation unit has succeeded in association with the imaging position and the imaging direction of the evaluation image; and an evaluation map update unit that updates the success-or-failure related information corresponding to the imaging position and the imaging direction estimated by the estimation unit in a case where the estimation by the estimation unit has succeeded, and updates the success-or-failure related information corresponding to the imaging position and the imaging direction indicated by the imaging information for evaluation in a case where the estimation by the estimation unit has failed, or a program for causing a computer to function as an information processing device.

An information processing method according to one aspect of the present technology, in which an information processing device including: an acquisition step acquiring an evaluation image captured by an imaging device and imaging information for evaluation that is imaging information indicating an imaging position and an imaging direction of the evaluation image; an estimation step of estimating the imaging position and the imaging direction of the evaluation image by performing matching between a feature point of a 3D map and a feature point of the evaluation image acquired by the acquisition step; a creation step of creating an evaluation map in which success-or-failure related information regarding whether or not the estimation by the estimation step has been successful is registered in association with the imaging position and the imaging direction of the evaluation image; and an evaluation map update step of updating the success-or-failure related information corresponding to the imaging position and the imaging direction estimated by the estimation step in a case where the estimation by the estimation step is successful, and updating the success-or-failure related information corresponding to the imaging position and the imaging direction indicated by the imaging information for evaluation in a case where the estimation by the estimation step fails.

In one aspect of the present technology, an evaluation image captured by an imaging device and imaging information for evaluation that is imaging information indicating an imaging position and an imaging direction of the evaluation image are acquired, the imaging position and the imaging direction of the evaluation image are estimated by performing matching between a feature point of a 3D map and a feature point of the evaluation image, success-or-failure related information regarding whether or not the estimation has been successful is registered in association with the imaging position and the imaging direction of the evaluation image, the success-or-failure related information corresponding to the imaging position and the imaging direction is updated in a case where the estimation is successful, and the success-or-failure related information corresponding to the imaging position and the imaging direction indicated by the imaging information for evaluation is updated in a case where the estimation fails.

Note that the information processing device according to one aspect of the present technology may be an independent device or may be a module incorporated in another device.

In order to implement the information processing device according to one aspect of the present technology, the program to be executed by the computer may be provided by being transmitted via a transmission medium or by being recorded on a recording medium.

### BRIEF DESCRIPTION OF DRAWINGS

FIG. 1 is a block diagram illustrating a configuration example of a first embodiment of an information processing system including an information processing device to which the present technology is applied.

FIG. 2 is a block diagram illustrating a configuration example of an imaging device in FIG. 1.

FIG. 3 is a block diagram illustrating a configuration example of a server in FIG. 1.

FIG. 4 is a block diagram illustrating a configuration example of a mobile terminal in FIG. 1.

FIG. 5 is a diagram illustrating a first configuration example of an evaluation screen.

FIG. 6 is a diagram illustrating an effect of the evaluation screen.

FIG. 7 is a flowchart illustrating creation processing.

FIG. 8 is a flowchart illustrating evaluation map update processing.

FIG. 9 is a block diagram illustrating a configuration example of a server in a second embodiment of the information processing system including the information processing device to which the present technology is applied.

FIG. 10 is a diagram illustrating a second configuration example of the evaluation screen.

FIG. 11 is a diagram illustrating a detailed configuration example of a circle in FIG. 10.

FIG. 12 is a block diagram illustrating a configuration example of a server in a third embodiment of the information processing system including the information processing device to which the present technology is applied.

FIG. 13 is a block diagram illustrating a configuration example of a mobile terminal in the third embodiment of the information processing system including the information processing device to which the present technology is applied.

FIG. 14 is a diagram illustrating a third configuration example of the evaluation screen.

FIG. 15 is a flowchart illustrating 3D map update processing.

FIG. 16 is a diagram illustrating an example of a shape of a grid.

FIG. 17 is a diagram illustrating an example of a distribution of the grids.

FIG. 18 is a diagram illustrating another example of the distribution of the grids.

FIG. 19 is a diagram illustrating another example of the shape of the grid.

FIG. 20 is a block diagram illustrating a configuration example of hardware of a computer.

### MODE FOR CARRYING OUT THE INVENTION

Hereinafter, modes for carrying out the present technology (hereinafter, referred to as embodiments) will be described. Note that the description is given in the following order.

1. First embodiment (information processing system for evaluating estimation for each imaging position and imaging direction)

2. Second embodiment (information processing system for evaluating estimation for each imaging position in predetermined range and imaging direction in predetermined range)

3. Third embodiment (information processing system for updating 3D model)

4. Grid

5. Computer

### 1. First Embodiment

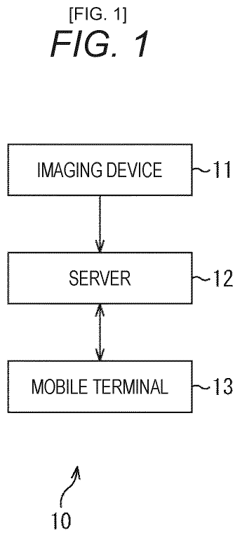

FIG. 1 is a block diagram illustrating a configuration example of a first embodiment of an information processing system including a server as an information processing device to which the present technology is applied.

An information processing system 10 in FIG. 1 includes an imaging device 11, a server 12, and a mobile terminal 13. The information processing system 10 creates a 3D map used in the VPS and displays an evaluation screen for evaluating the VPS using the 3D map.

Specifically, the imaging device 11 is used, for example, when a provider who provides the VPS creates a 3D map. The imaging device 11 images a predetermined region at a plurality of imaging positions and a plurality of imaging directions determined by the provider. The imaging device 11 transmits, to the server 12, a resultant image group including a plurality of captured images having different imaging positions and imaging directions, and meta information indicating an imaging position or the like of each captured image of the image group.

The server 12 is a device that executes the VPS. The server 12 receives the image group and the meta information transmitted from the imaging device 11. The server 12 creates a 3D map (3D model) of the predetermined region using the image group and the meta information. The creation of the 3D map can be realized, for example, by executing open source called COLMAP described in Non-Patent Document 1. COLMAP is a pipeline of structure-from-motion (SfM) and multi-view stereo (MVS).

The server 12 also receives an evaluation image that is an image for evaluation of the VPS transmitted from the mobile terminal 13, and imaging information for evaluation that is imaging information indicating the imaging position and the imaging direction of the evaluation image. The server 12 estimates the imaging position and the imaging direction (a posture of the mobile terminal 13 at the time of imaging) of the evaluation image using the 3D map. The server 12 generates display control information to be used for displaying the evaluation screen on the basis of the estimation result, and transmits the display control information to the mobile terminal 13.

The mobile terminal 13 is used, for example, when the VPS is evaluated by a provider who provides the VPS. The mobile terminal 13 (imaging device) captures an evaluation image and transmits the evaluation image and the imaging information for evaluation to the server 12. The mobile terminal 13 receives the display control information transmitted from the server 12, and displays the evaluation screen on the basis of the display control information.

### Configuration Example of Imaging Device

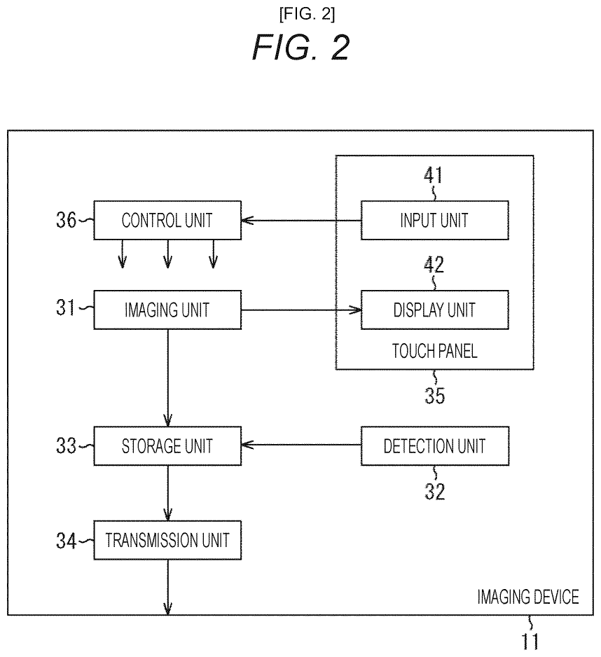

FIG. 2 is a block diagram illustrating a configuration example of the imaging device 11 in FIG. 1.

The imaging device 11 in FIG. 2 includes an imaging unit 31, a detection unit 32, a storage unit 33, a transmission unit 34, a touch panel 35, and a control unit 36.

The imaging unit 31 images a predetermined region with the current position of the imaging device 11 as the imaging position and the current direction of the imaging device 11 as the imaging direction. The imaging unit 31 supplies the resultant captured image to the touch panel 35 to cause the touch panel 35 to display the captured image, and supplies the captured image to the storage unit 33 to cause the storage unit 33 to store the captured image.

The detection unit 32 includes a global positioning system (GPS) sensor, a gravity sensor, a self-position estimation unit that estimates a self-position using a simultaneous localization and mapping (SLAM) technology, an acquisition unit that acquires setting information and semantic information input by a provider, a depth sensor, and the like. The detection unit 32 acquires, for each captured image, meta information including an imaging position detected by the GPS sensor, gravity information indicating a detection result of the gravity sensor, a self-position estimation result of the self-position estimation unit, setting information, semantic information, depth information indicating a detection result of the depth sensor, and the like. The detection unit 32 supplies the meta information to the storage unit 33, to cause the storage unit 33 to store the meta information in association with the captured image.

The storage unit 33 stores the captured image supplied from the imaging unit 31 and the meta information of the captured image supplied from the detection unit 32 in association with each other.

The transmission unit 34 reads the image group and the meta information of each captured image of the image group from the storage unit 33, and transmits the image group and the meta information to the server 12.

The touch panel 35 includes an input unit 41 and a display unit 42. The input unit 41 receives a touch operation by a provider and supplies an operation signal indicating the touch operation to the control unit 36. The display unit 42 displays the captured image and the like supplied from the imaging unit 31. The provider selects an image to be used for creating a 3D map by performing a touch operation while viewing the captured image displayed on the display unit 42, for example. For example, the provider moves the imaging device 11 to a desired imaging position and performs a touch operation in a desired imaging direction, thereby issuing an imaging command. These touch operations are received by the input unit 41.

The control unit 36 controls each unit of the imaging device 11. For example, the control unit 36 controls the transmission unit 34 on the basis of the operation signal supplied from the input unit 41, and causes the server 12 to transmit an image group and the meta information of the image group, the image group including the captured image selected by the provider as the image to be used for creating the 3D map. For example, the control unit 36 causes the imaging unit 31 to perform imaging at a timing desired by the provider on the basis of the operation signal supplied from the input unit 41.

### Configuration Example of Server

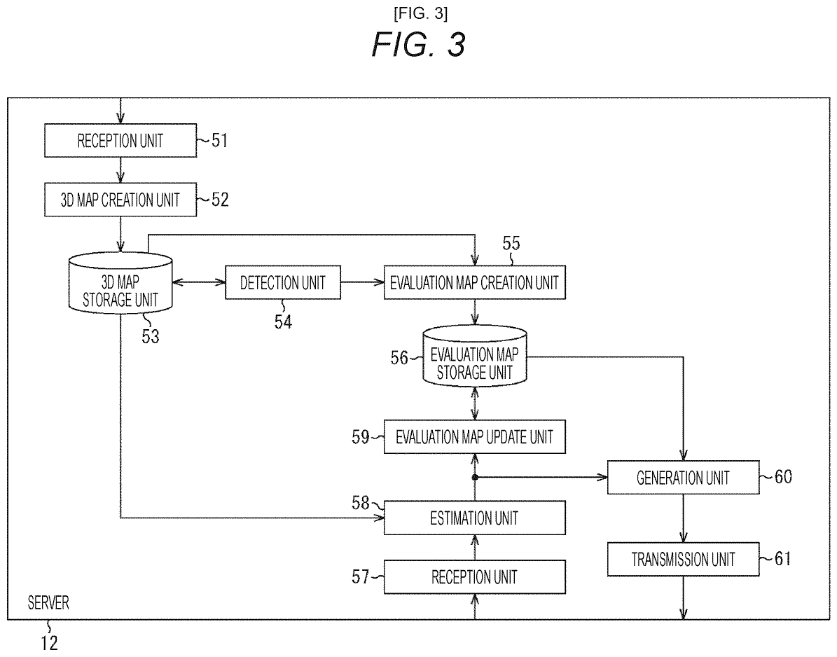

FIG. 3 is a block diagram illustrating a configuration example of the server 12 in FIG. 1.

The server 12 in FIG. 3 includes a reception unit 51, a 3D map creation unit 52, a 3D map storage unit 53, a detection unit 54, an evaluation map creation unit 55, an evaluation map storage unit 56, a reception unit 57, an estimation unit 58, an evaluation map update unit 59, a generation unit 60, and a transmission unit 61.

The reception unit 51 receives the image group and the meta information transmitted from the transmission unit 34 of the imaging device 11, and supplies the image group and the meta information to the 3D map creation unit 52.

The 3D map creation unit 52 creates a 3D map using the image group and the meta information supplied from the reception unit 51. The 3D map creation unit 52 supplies the 3D map to the 3D map storage unit 53.

The 3D map storage unit 53 stores the 3D map and the like supplied from the 3D map creation unit 52.

The detection unit 54 reads the 3D map from the 3D map storage unit 53. The detection unit 54 detects a ground region from the 3D map. As a method of detecting the ground region, for example, there is a method of using segmentation and principal component analysis (PCA).

Note that the detection unit 54 may also read the meta information from the 3D map storage unit 53 and detect the ground region from the 3D map using the meta information. In this case, the detection unit 54 detects the ground region from the 3D map using, for example, gravity information, setting information such as body information of the provider, semantic information, depth information, and the like included in the meta information. Alternatively, for example, the detection unit 54 detects, as the ground region, a surface including a surface formed by connecting the self-position estimation result on the 3D map on the basis of the trajectory of the self-position estimation result included in the meta information.

In a case where an inertial measurement unit (IMU) is included in the detection unit 32 of the imaging device 11, and the angular velocity and the acceleration of the imaging device 11 detected by the IMU are included in the meta information, the detection unit 54 can also detect the ground region using the angular velocity and the acceleration, and the PCA. The detection unit 54 can also detect the ground region using the 3D model of the object included in the 3D map.

The detection unit 54 determines a posture (direction) of the 3D map with respect to the real-world coordinate system on the basis of the ground region. The detection unit 54 updates the posture of the 3D map stored in the 3D map storage unit 53 on the basis of the posture. The detection unit 54 supplies ground region information indicating the position of the ground region on the 3D map to the evaluation map creation unit 55.

The evaluation map creation unit 55 reads the 3D map from the 3D map storage unit 53. The evaluation map creation unit 55 creates an evaluation map in the ground region on the 3D map on the basis of the ground region information supplied from the detection unit 54. The evaluation map is a map for registering success-or-failure related information regarding whether or not the estimation by the estimation unit 58 for the evaluation image has been successful in association with the imaging position and the imaging direction of the evaluation image. In the first embodiment, the success-or-failure related information is success-or-failure information indicating whether or not the estimation has been successful, that is, whether the estimation has been successful or failed. The evaluation map creation unit 55 supplies the evaluation map to the evaluation map storage unit 56.

The evaluation map storage unit 56 stores the evaluation map supplied from the evaluation map creation unit 55.

The reception unit 57 (acquisition unit) receives (acquires) the evaluation image and the imaging information for evaluation transmitted from the mobile terminal 13, and supplies the evaluation image and the imaging information for evaluation to the estimation unit 58.

The estimation unit 58 reads the 3D map from the 3D map storage unit 53. The estimation unit 58 estimates the imaging position and the imaging direction of the evaluation image by performing matching between the feature point of the 3D map and the feature point of the evaluation image supplied from the reception unit 57. This estimation can be implemented, for example, by executing software provided in <URL: https://www.graphics.rwth-aachen.de/software/image-localization/>.

In a case where the estimation is successful, the estimation unit 58 supplies estimated imaging information indicating the estimated imaging position and imaging direction to the evaluation map update unit 59 and the generation unit 60. In a case where the estimation fails, the estimation unit 58 supplies the imaging information for evaluation supplied from the reception unit 57 to the evaluation map update unit 59 and the generation unit 60.

The evaluation map update unit 59 reads the evaluation map from the evaluation map storage unit 56. The evaluation map update unit 59 acquires the estimated imaging information or the imaging information for evaluation supplied from the estimation unit 58. The evaluation map update unit 59 updates the evaluation map by updating the success-or-failure information corresponding to the imaging position and the imaging direction indicated by the estimated imaging information or the imaging information for evaluation of the evaluation map.

Specifically, the evaluation map update unit 59 updates the success-or-failure information corresponding to the imaging position and the imaging direction indicated by the estimated imaging information of the evaluation map to success-or-failure information indicating that the estimation has been successful. The evaluation map update unit 59 updates the success-or-failure information corresponding to the imaging position and the imaging direction indicated by the imaging information for evaluation of the evaluation map to success-or-failure information indicating that the estimation has failed. The evaluation map update unit 59 supplies the updated evaluation map to the evaluation map storage unit 56, and updates the evaluation map stored in the evaluation map storage unit 56.

The generation unit 60 reads the evaluation map stored in the evaluation map storage unit 56. The generation unit 60 acquires the estimated imaging information or the imaging information for evaluation supplied from the estimation unit 58. The generation unit 60 generates display control information on the basis of the evaluation map and the estimated imaging information or the imaging information for evaluation. This display control information is information for displaying, at each imaging position registered in the evaluation map on the evaluation image, the direction information indicating each imaging direction and the success-or-failure information registered in the evaluation map in association with the imaging position. The generation unit 60 supplies the display control information to the transmission unit 61.

The transmission unit 61 transmits the display control information supplied from the generation unit 60 to the mobile terminal 13.

### Configuration Example of Mobile Terminal

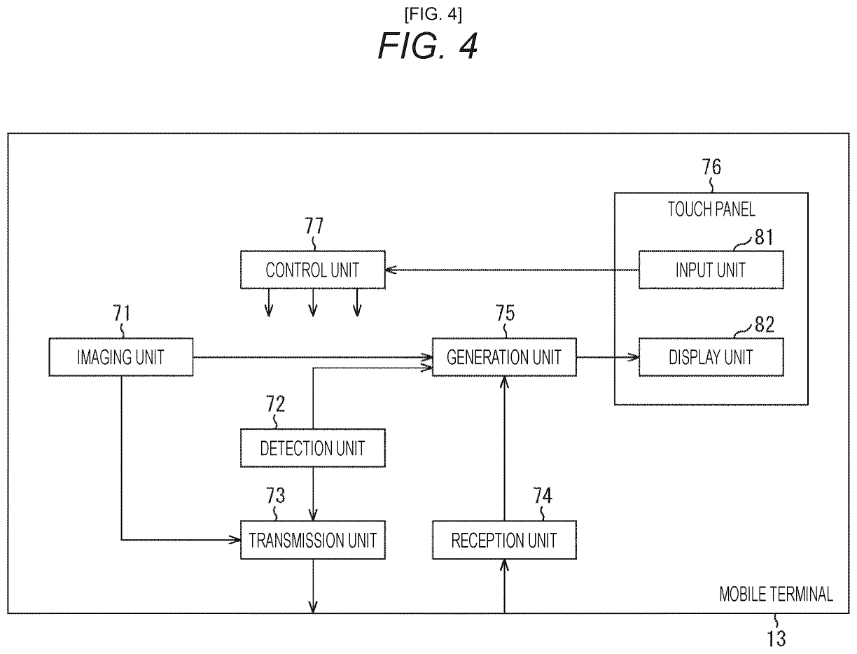

FIG. 4 is a block diagram illustrating a configuration example of the mobile terminal 13 in FIG. 1.

The mobile terminal 13 in FIG. 4 includes an imaging unit 71, a detection unit 72, a transmission unit 73, a reception unit 74, a generation unit 75, a touch panel 76, and a control unit 77.

The imaging unit 71 images a predetermined region with the current position of the mobile terminal 13 as the imaging position and the current direction of the mobile terminal 13 as the imaging direction. The imaging unit 71 supplies a captured image being captured in real time to the generation unit 75 as a camera view image. The imaging unit 71 supplies a captured image at a predetermined timing to the transmission unit 73 as an evaluation image.

The detection unit 72 includes a GPS sensor, a gravity sensor, a self-position estimation unit, and the like. As a method of estimating the current position by the self-position estimation unit, for example, there is a method of estimating the current position by a movement amount, a movement direction, and the like from the past position and time constraint. The detection unit 72 detects the imaging position and the imaging direction of each captured image. The detection unit 72 supplies the imaging information for evaluation to the transmission unit 73 on the basis of the detection result, and supplies camera view imaging information that is imaging information of the camera view image to the generation unit 75.

The transmission unit 73 transmits the evaluation image supplied from the imaging unit 71 and the imaging information for evaluation supplied from the detection unit 72 to the server 12.

The reception unit 74 receives the display control information transmitted from the server 12 and supplies the display control information to the generation unit 75. The generation unit 75 generates an evaluation screen in which the direction information and the success-or-failure information are superimposed on the imaging position of each evaluation image of the camera view image supplied from the imaging unit 71 on the basis of the camera view imaging information supplied from the detection unit 72 and the display control information supplied from the reception unit 74. The generation unit 75 supplies the evaluation screen to the touch panel 76.

The touch panel 76 includes an input unit 81 and a display unit 82. The input unit 81 receives a touch operation by a provider and supplies an operation signal indicating the touch operation to the control unit 77. The display unit 82 displays the evaluation screen and the like supplied from the generation unit 75. For example, the provider performs a touch operation while viewing the camera view image displayed by the display unit 82, thereby selecting the camera view image displayed at that time as the evaluation image. This touch operation is received by the input unit 81.

The control unit 77 controls each unit of the mobile terminal 13. For example, the control unit 77 controls the imaging unit 71 and the detection unit 72 on the basis of the operation signal supplied from the input unit 81, and supplies the evaluation image selected by the provider and the imaging information for evaluation of the evaluation image to the transmission unit 73.

### Configuration Example of Evaluation Screen

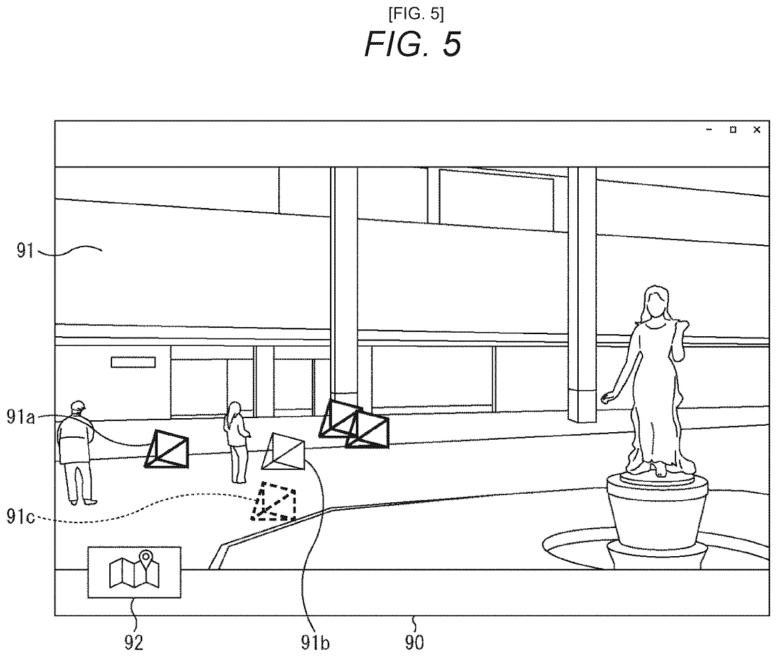

FIG. 5 is a diagram illustrating a configuration example of the evaluation screen.

On an evaluation screen 90 in FIG. 5, a camera view image 91 and an evaluation image button 92 are displayed. At the imaging position of each evaluation image of the camera view image 91, one of two types of view cones (viewing cones) 91a and 91b is displayed as the direction information and the success-or-failure information.

Specifically, in each of the view cones 91a and 91b, one vertex is disposed at the imaging position, and the direction of a perpendicular line from the vertex to the bottom surface represents the imaging direction. The types of the view cones 91a and 91b indicate success or failure of estimation by the estimation unit 58. In the example of FIG. 5, the types of the view cones 91a and 91b are line types. The view cone 91a with a thick solid line indicates that the estimation by the estimation unit 58 has been successful, and the view cone 91b with a thin solid line indicates that the estimation by the estimation unit 58 has failed.

In the example of FIG. 5, the imaging position of the mobile terminal 13 moves during the estimation by the estimation unit 58, and a view cone 91c is also displayed on the camera view image 91 on the basis of the imaging information for evaluation of the evaluation image corresponding to the estimation. This view cone 91c differs from the view cones 91a and 91b in that the line type is a dotted line, and is otherwise configured similarly to the view cones 91a and 91b. After the end of the estimation, the view cone 91c is changed to the view cone 91a in a case where the estimation is successful, and is changed to the view cone 91b in a case where the estimation fails.

Note that the types of the view cones 91a to 91c may be types of colors other than lines, for example.

The evaluation image button 92 is touched and operated by the provider in a case where the camera view image 91 is selected as the evaluation image. When the provider performs a touch operation on the evaluation image button 92, the touch operation is received by the input unit 81, and an operation signal indicating the touch operation is supplied to the control unit 77. As a result, under the control of the control unit 77, the camera view image 91 displayed when the provider performs the touch operation is transmitted to the server 12 as the evaluation image. Furthermore, under the control of the control unit 77, the camera view imaging information of the camera view image 91 is transmitted to the server 12 as the imaging information for evaluation.

### Description of Effect

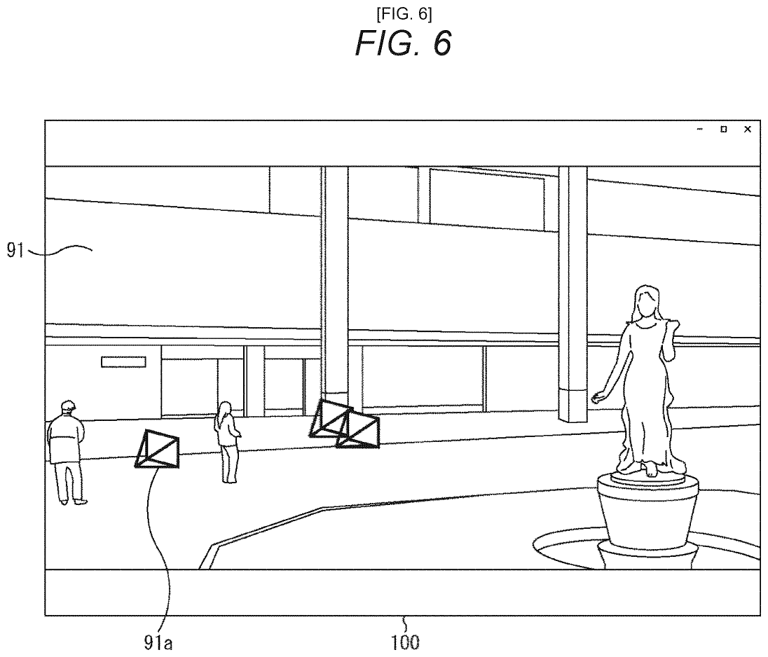

FIG. 6 is a diagram illustrating an effect of the evaluation screen 90.

As illustrated in FIG. 6, on the evaluation screen 100 in which only the view cone 91a in a case where estimation is successful is superimposed on the camera view image 91, the provider cannot recognize the imaging position and the imaging direction for which the estimation has failed.

On the other hand, on the evaluation screen 90, not only the view cone 91a in a case where the estimation is successful but also the view cone 91b in a case where the estimation fails are superimposed on the camera view image 91. Therefore, the provider can recognize the imaging position and the imaging direction in both the case where the estimation is successful and the case where the estimation fails.

### Description of Processing by Server

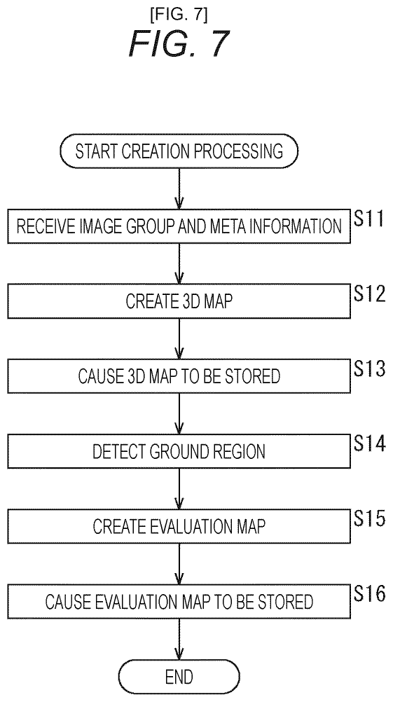

FIG. 7 is a flowchart illustrating creation processing in which the server 12 creates a 3D map. This creation processing is started, for example, when an image group and meta information are transmitted from the imaging device 11.

In step S11 of FIG. 7, the reception unit 51 receives the image group and the meta information transmitted from the transmission unit 34 and supplies the image group and the meta information to the 3D map creation unit 52. In step S12, the 3D map creation unit 52 creates the 3D map using the image group and the meta information received by the processing in step S11. In step S13, the 3D map creation unit 52 supplies the 3D map created by the processing in step S12 to the 3D map storage unit 53 to cause the 3D map storage unit 53 to store the 3D map.

In step S14, the detection unit 54 reads the 3D map stored by the processing in step S13, and detects ground region from the 3D map. The detection unit 54 updates the posture of the 3D map stored in the 3D map storage unit 53 on the basis of the ground region information. The detection unit 54 supplies the ground region information to the evaluation map creation unit 55.

In step S15, the evaluation map creation unit 55 reads the 3D map from the 3D map storage unit 53, and creates the evaluation map in the ground region on the 3D map on the basis of the ground region information supplied from the detection unit 54. In step S16, the evaluation map creation unit 55 supplies the evaluation map created by the processing in step S15 to the evaluation map storage unit 56 to cause the evaluation map storage unit 56 to store the evaluation map. Then, the process ends.

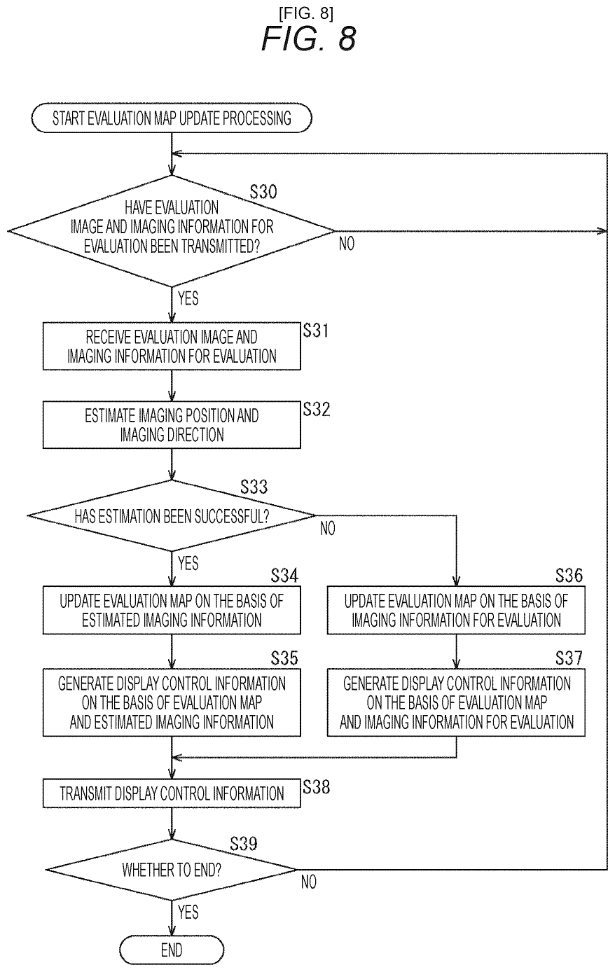

FIG. 8 is a flowchart illustrating evaluation map update processing in which the server 12 updates the evaluation map.

In step S30 of FIG. 8, the reception unit 57 determines whether or not the evaluation image and the imaging information for evaluation have been transmitted from the mobile terminal 13. In a case where it is determined in step S30 that the evaluation image and the imaging information for evaluation have not been transmitted, the process waits until the evaluation image and the imaging information for evaluation are transmitted.

On the other hand, in a case where it is determined in step S30 that the evaluation image and the imaging information for evaluation have been transmitted, the process proceeds to step S31. In step S31, the reception unit 57 receives the evaluation image and the imaging information for evaluation transmitted from the mobile terminal 13, and supplies the evaluation image and the imaging information for evaluation to the estimation unit 58.

In step S32, the estimation unit 58 estimates the imaging position and the imaging direction of the evaluation image by performing matching between the feature point of the 3D map stored in the 3D map storage unit 53 and the feature point of the evaluation image received by the processing in step S31.

In step S33, the estimation unit 58 determines whether or not the estimation has been successful. Specifically, for example, the estimation unit 58 calculates the likelihood of the estimation result. In a case where the likelihood is a predetermined value or more, the estimation unit 58 determines that the estimation has been successful, and in a case where the likelihood is less than the predetermined value, the estimation unit 58 determines that the estimation has not been successful.

In a case where it is determined in step S33 that the estimation has been successful, the estimation unit 58 supplies the estimated imaging information to the evaluation map update unit 59 and the generation unit 60, and the process proceeds to step S34.

In step S34, the evaluation map update unit 59 reads the evaluation map from the evaluation map storage unit 56, and updates the evaluation map on the basis of the estimated imaging information. The evaluation map update unit 59 supplies the updated evaluation map to the evaluation map storage unit 56, and updates the evaluation map stored in the evaluation map storage unit 56.

In step S35, the generation unit 60 generates the display control information on the basis of the evaluation map updated in step S34 and the estimated imaging information supplied from the estimation unit 58. The generation unit 60 supplies the display control information to the transmission unit 61, and the process proceeds to step S38.

On the other hand, in a case where it is determined in step S33 that the estimation has not been successful, that is, in a case where it is determined that the estimation has failed, the estimation unit 58 supplies the imaging information for evaluation received by the processing in step S31 to the evaluation map update unit 59 and the generation unit 60, and the process proceeds to step S36.

In step S36, the evaluation map update unit 59 reads the evaluation map from the evaluation map storage unit 56, and updates the evaluation map on the basis of the imaging information for evaluation. The evaluation map update unit 59 supplies the updated evaluation map to the evaluation map storage unit 56, and updates the evaluation map stored in the evaluation map storage unit 56.

In step S37, the generation unit 60 generates the display control information on the basis of the evaluation map updated in step S36 and the imaging information for evaluation supplied from the estimation unit 58. The generation unit 60 supplies the display control information to the transmission unit 61, and the process proceeds to step S38.

In step S38, the transmission unit 61 transmits the display control information generated in step S35 or S37 to the mobile terminal 13.

In step S39, the server 12 determines whether or not to end the evaluation map update processing. For example, in a case where the provider gives a command to end the evaluation by performing a touch operation on the touch panel 76, and as a result, a command to end the evaluation is transmitted from the transmission unit 73 to the server 12 under the control of the control unit 77, the server 12 determines to end the evaluation map update processing. Note that, in a case where the number of pieces of success-or-failure information registered on the evaluation map is a predetermined number or more, the server 12 may determine to end the evaluation map update processing.

In a case where it is determined in step S39 that the evaluation map update processing is not ended, the process returns to step S30 and the subsequent processes are repeated.

On the other hand, in a case where it is determined in step S39 that the evaluation map update processing is to be ended, the process ends.

As described above, the server 12 acquires the evaluation image and the imaging information for evaluation, estimates the imaging position and the imaging direction of the evaluation image, creates the evaluation map in which the success-or-failure related information is registered in association with the imaging position and the imaging direction of the evaluation image, updates the success-or-failure related information corresponding to the estimated imaging information in a case where the estimation is successful, and updates the success-or-failure related information corresponding to the imaging information for evaluation in a case where the estimation fails. Therefore, in the case of estimating the imaging position and the imaging direction, it is possible to provide the imaging position and the imaging direction in both the case where the estimation is successful and the case where the estimation fails.

### 2. Second Embodiment

### Configuration Example of Server

The configuration of a second embodiment of the information processing system including the server as the information processing device to which the present technology is applied is similar to the configuration of the information processing system 10 in FIG. 1 except for the server and the evaluation screen. Therefore, the following description focuses on the server and the evaluation screen in the second embodiment.

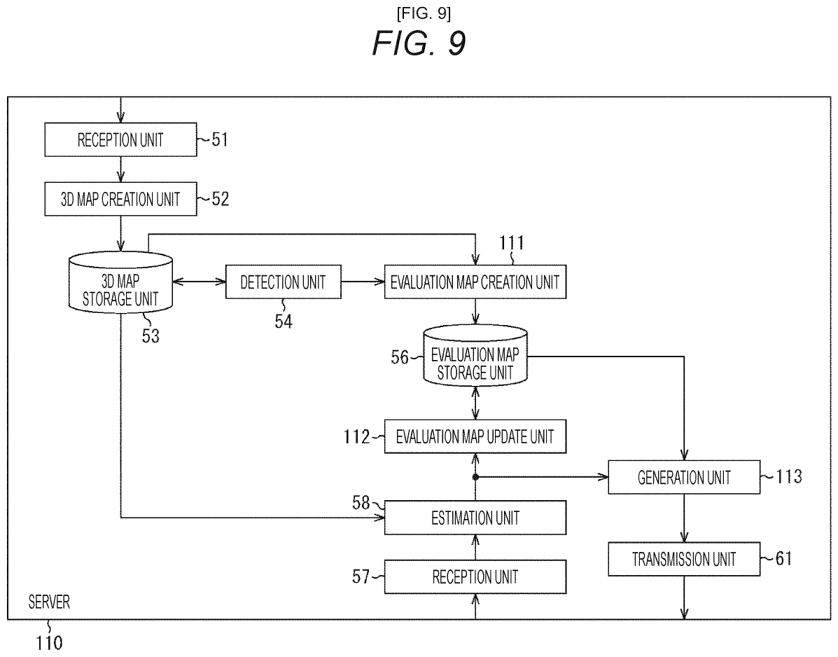

FIG. 9 is a block diagram illustrating a configuration example of a server in the second embodiment.

In a server 110 in FIG. 9, the units corresponding to those of the server 12 in FIG. 3 are denoted by the same reference numerals. Therefore, description of the units will be appropriately omitted, and description will be given focusing on units different from the server 12. The server 110 is different from the server 12 in that the server 110 includes an evaluation map creation unit 111, an evaluation map update unit 112, and a generation unit 113 instead of the evaluation map creation unit 55, the evaluation map update unit 59, and the generation unit 60, and the other units are configured similarly to the server 12. The server 110 registers the success-or-failure related information for each imaging position in a predetermined range and each imaging direction in a predetermined range in the evaluation map.

Specifically, the evaluation map creation unit 111 reads the 3D map from the 3D map storage unit 53. The evaluation map creation unit 111 creates the evaluation map by forming a plurality of grids in the ground region on the 3D map on the basis of the ground region information supplied from the detection unit 54. In this evaluation map, direction range information and success-or-failure related information are registered in association with each grid, the direction range information indicating the range of the imaging direction of the evaluation image in which the imaging position exists in the region corresponding to each grid. That is, in this evaluation map, the success-or-failure related information is registered for each imaging position in a predetermined range and each imaging direction in a predetermined range. In the second embodiment, the success-or-failure related information is success rate information indicating a success rate of estimation. The evaluation map creation unit 111 supplies the evaluation map to the evaluation map storage unit 56.

The evaluation map update unit 112 reads the evaluation map from the evaluation map storage unit 56. The evaluation map update unit 112 acquires the estimated imaging information or the imaging information for evaluation supplied from the estimation unit 58. The evaluation map update unit 112 updates the evaluation map by updating the success rate information corresponding to the grid corresponding to the imaging position indicated by the estimated imaging information or the imaging information for evaluation of the evaluation map and the direction range information of the imaging direction. The evaluation map update unit 112 supplies the updated evaluation map to the evaluation map storage unit 56, and updates the evaluation map stored in the evaluation map storage unit 56.

The generation unit 113 reads the evaluation map stored in the evaluation map storage unit 56. The generation unit 113 acquires the estimated imaging information or the imaging information for evaluation supplied from the estimation unit 58. The generation unit 113 generates the display control information on the basis of the evaluation map and the estimated imaging information or the imaging information for evaluation. The display control information is information for displaying the direction range information and the success rate information registered in association with each grid of the evaluation map at a position corresponding to each grid on the evaluation image. The generation unit 113 supplies the display control information to the transmission unit 61.

### Configuration Example of Evaluation Screen

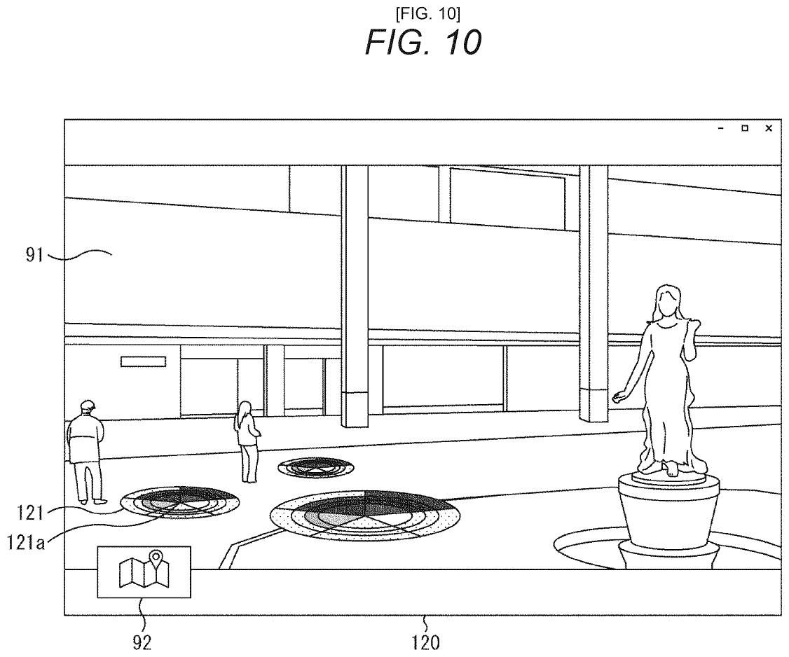

FIG. 10 is a diagram illustrating a configuration example of an evaluation screen displayed on the mobile terminal 13 on the basis of the display control information generated by the server 110.

In the evaluation screen 120 in FIG. 10, the portions corresponding to the evaluation screen 90 of FIG. 5 are denoted by the same reference signs. Therefore, the description of the portions will be appropriately omitted, and the following description will be provided focusing on portions different from the evaluation screen 90. The evaluation screen 120 is different from the evaluation screen 90 in that a circle 121 is provided instead of the view cones 91a and 91b and that the view cone 91c is not provided, and the other portions are configured similarly to the evaluation screen 90.

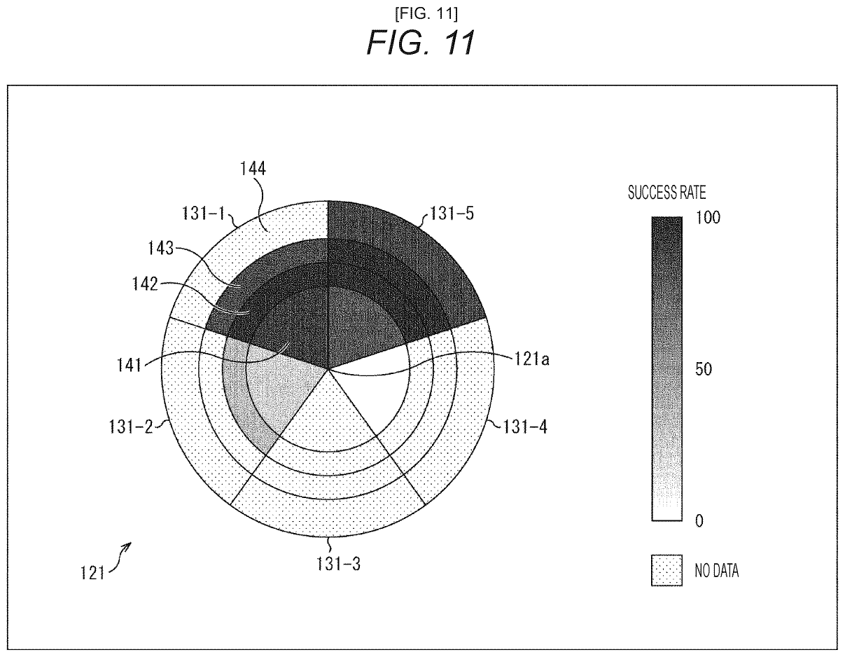

On the evaluation screen 120, with a position corresponding to each grid on the camera view image 91 as a center 121a, the circle 121 as direction range information and success rate information corresponding to the grid is superimposed. A detailed configuration of this circle 121 will be described with reference to FIG. 11 described later.

### Detailed Configuration Example of Circle

FIG. 11 is a diagram illustrating a detailed configuration example of the circle 121 in FIG. 10.

In the example of FIG. 11, the imaging directions are classified into five ranges of every 72 degrees. Therefore, the circle 121 is divided into five fan-shaped regions 131-1 to 131-5 having a central angle of 72 degrees. Note that, hereinafter, in a case where it is not necessary to individually distinguish the regions 131-1 to 131-5, the regions are collectively referred to as a region 131. Each region 131 is direction range information indicating that the imaging direction is a range the end point of which is included in the region 131 when the center 121a of the circle 121 is set as the start point. The density of each region 131 is success rate information.

In the example of FIG. 11, the success rate information is information indicating the success rate for each of the four ranges of the number of times of trial of estimation by the estimation unit 58. Therefore, each region 131 is further divided into four regions 141 to 144. The region 141 closest to the center 121a has a fan shape, and the other regions 142 to 144 each have an annular shape.

The density of the region 141 represents, for example, a success rate in a case where the number of times of trial of estimation is less than 5 times, and the density of the region 142 represents, for example, a success rate in a case where the number of times of trial for estimation is 5 times or more and less than 10 times. The density of the region 143 represents, for example, a success rate in a case where the number of times of trial for estimation is 10 times or more and less than 15 times, and the density of the region 144 represents, for example, a success rate in a case where the number of times of trial for estimation is 15 times or more. Note that, in a case where estimation has not been performed as many times as the number of times of trial corresponding to the regions 141 to 144, the regions 141 to 144 are denoted with a polka dot pattern as information indicating that there is no data.

In the example of FIG. 11, the number of times of trial of estimation for the evaluation image corresponding to the range of the imaging position corresponding to the circle 121 and the range of the imaging direction corresponding to the region 131-1 is less than 15 times. Therefore, the regions 141 to 143 in the region 131-1 are each denoted with a density representing the corresponding success rate, while the region 144 is denoted with a polka dot pattern.

In the example of FIG. 11, the number of times of trial of estimation for the evaluation image corresponding to the range of the imaging position corresponding to the circle 121 and the range of the imaging direction corresponding to the region 131-2 is less than 10 times. Therefore, the regions 141 and 142 in the region 131-2 are each denoted with a density representing the corresponding success rate, while the regions 143 and 144 are denoted with a polka dot pattern.

In the example of FIG. 11, estimation for the evaluation image corresponding to the range of the imaging position corresponding to the circle 121 and the range of the imaging direction corresponding to the region 131-3 has not yet been performed. Therefore, the regions 141 to 144 in the region 131-3 are denoted with a polka dot pattern.

In the example of FIG. 11, the number of times of trial of estimation for the evaluation image corresponding to the range of the imaging position corresponding to the circle 121 and the range of the imaging direction corresponding to the region 131-4 is less than 5 times. Therefore, the region 141 in the region 131-4 is denoted with a density representing the corresponding success rate, while the regions 142 to 144 are denoted with a polka dot pattern.

In the example of FIG. 11, the number of times of trial of estimation for the evaluation image corresponding to the range of the imaging position corresponding to the circle 121 and the range of the imaging direction corresponding to the region 131-5 is 15 times or more. Therefore, the regions 141 to 144 in the region 131-5 are each denoted with a density representing the corresponding success rate.

Note that the success rate may be represented by characters, colors, patterns, and the like other than density. The information indicating that there is no data may be a predetermined pattern other than the polka dot pattern, a predetermined character, a predetermined color, a predetermined density, or the like. The density of the regions 141 to 144 may become lower as time elapses, that is, close to the density representing zero.

The success rate information may be information indicating a success rate for each time from the time when the estimation is successful. In this case, the success rates represented by the densities of the regions 141 to 144 do not differ in the number of times of estimation, but differ in the time after the estimation has succeeded. The success rate information may be information indicating a success rate for each height or pitch of the mobile terminal 13 at the time of imaging. In this case, the success rate represented by the densities of the regions 141 to 144 is not different in the number of times of estimation, but is different in the height or pitch of the mobile terminal 13 at the time of imaging.

As described above, the server 110 quantizes the imaging position and the imaging direction, and registers the success rate information as the success-or-failure related information in correspondence with the imaging position in the predetermined range and the imaging direction in the predetermined range in the evaluation map. Therefore, it is possible to suppress an increase in the direction information and the success-or-failure related information superimposed on the camera view image 91 due to an increase in the number of times of trial of estimation. As a result, the provider can easily recognize the success-or-failure related information for each of the imaging position in the predetermined range and the imaging direction in the predetermined range even in a case where the number of times of trial of estimation increases.

Note that the flowchart of the creation processing and the evaluation map update processing of the server 110 is similar to the flowchart of the creation processing in FIG. 7 and the evaluation map update processing in FIG. 8, and thus, description thereof is omitted.

As described above, similarly to the server 12, the server 110 acquires the evaluation image and the imaging information for evaluation, estimates the imaging position and the imaging direction of the evaluation image, creates the evaluation map, updates the success-or-failure related information corresponding to the estimated imaging information of the evaluation map in a case where the estimation is successful, and updates the success-or-failure related information corresponding to the imaging information for evaluation of the evaluation map in a case where the estimation fails. Therefore, in the case of estimating the imaging position and the imaging direction, it is possible to provide the imaging position and the imaging direction in both the case where the estimation is successful and the case where the estimation fails.

Furthermore, the evaluation map created by the server 110 is an evaluation map in which, in association with each grid of a plurality of grids formed on the 3D map, direction range information of an evaluation image in which an imaging position exists in a region corresponding to each grid and success-or-failure related information are registered. Therefore, even in a case where the number of times of trial of estimation increases, it is possible to simply provide the range of the imaging position and the range of the imaging direction in both a case where estimation is successful and a case where estimation fails.

### 3. Third Embodiment

### Configuration Example of Server

The configuration of a third embodiment of the information processing system including the server as the information processing device to which the present technology is applied is similar to the configuration of the information processing system of the second embodiment except for the server and the mobile terminal. Therefore, the following description focuses on the server and the mobile terminal in the third embodiment.

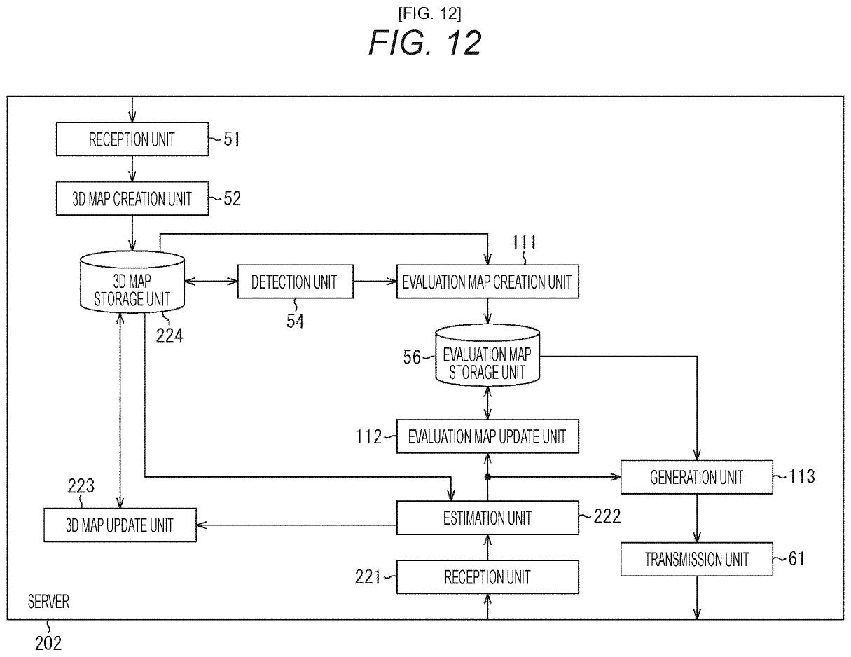

FIG. 12 is a block diagram illustrating a configuration example of a server in the third embodiment.

In a server 202 in FIG. 12, the units corresponding to those of the server 110 in FIG. 9 are denoted by the same reference numerals. Therefore, description of the units will be appropriately omitted, and description will be given focusing on units different from the server 110. The server 202 is different from the server 110 in that the server 202 includes a reception unit 221, an estimation unit 222, and a 3D map storage unit 224 instead of the reception unit 57, the estimation unit 58, and the 3D map storage unit 53, and newly includes a 3D map update unit 223. The other units are configured similarly to the server 110. The server 202 also updates the 3D map using an update image (key frame) that is an image for updating the 3D map transmitted from a mobile terminal 203 described later.

Specifically, the reception unit 221 of the server 202 receives the evaluation image and the imaging information for evaluation transmitted from the mobile terminal 203, and supplies the evaluation image and the imaging information for evaluation to the estimation unit 222. The reception unit 221 (acquisition unit) also receives (acquires) the update image and the imaging information for update, which is imaging information of the update image, transmitted from the mobile terminal 203, and supplies the update image and the imaging information for update to the estimation unit 222.

The estimation unit 222 reads the 3D map from the 3D map storage unit 53. Similarly to the estimation unit 58, the estimation unit 222 estimates the imaging position and the imaging direction of the evaluation image using the 3D map and the evaluation image. In a case where the estimation is successful, the estimation unit 222 supplies the estimated imaging information to the evaluation map update unit 112 and the generation unit 113. In a case where the estimation fails, the estimation unit 222 supplies the imaging information for evaluation supplied from the reception unit 221 to the evaluation map update unit 112 and the generation unit 113.

Similarly to the case of the evaluation image, the estimation unit 222 also estimates the imaging position and the imaging direction of the update image using the 3D map and the update image. In a case where the estimation is successful, the estimation unit 222 supplies the estimated imaging information and the update image to the 3D map update unit 223. In a case where the estimation fails, the estimation unit 222 supplies the imaging information for update and the update image supplied from the reception unit 221 to the 3D map update unit 223.

The 3D map update unit 223 reads the 3D map from the 3D map storage unit 224. The 3D map update unit 223 updates the 3D map using the update image and, the estimated imaging information or the imaging information for update supplied from the estimation unit 222. The 3D map update unit 223 supplies the updated 3D map to the 3D map storage unit 224.

The 3D map storage unit 224 stores the 3D map supplied from the 3D map creation unit 52. The 3D map storage unit 224 updates the stored 3D map with the updated 3D map supplied from the 3D map update unit 223.

### Configuration Example of Mobile Terminal

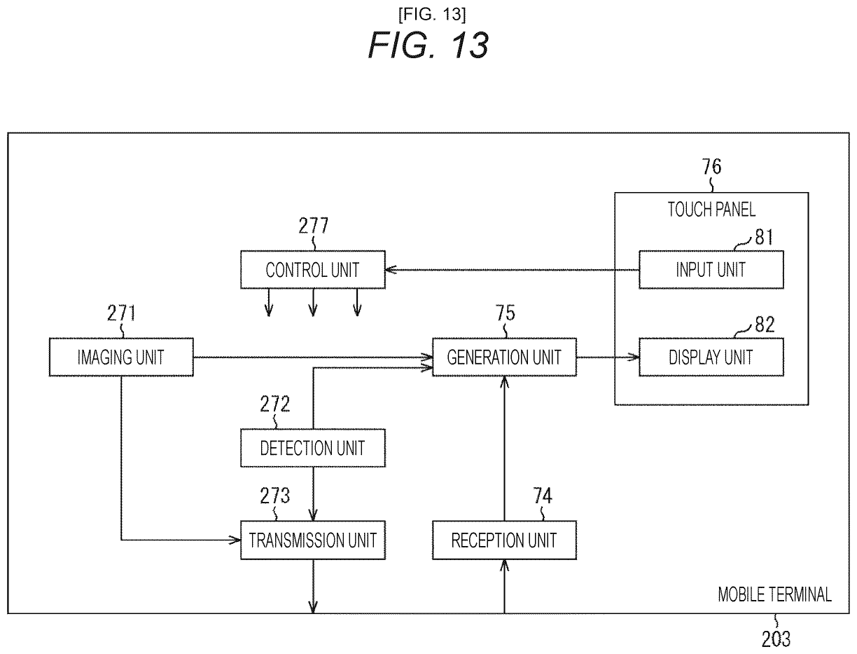

FIG. 13 is a block diagram illustrating a configuration example of the mobile terminal in the third embodiment.

In the mobile terminal 203 of FIG. 13, the units corresponding to those of the mobile terminal 13 of FIG. 4 are denoted by the same reference numerals. Therefore, description of the units will be appropriately omitted, and description will be given focusing on units different from the mobile terminal 13. The mobile terminal 13 is different from the mobile terminal 13 in that the mobile terminal 13 includes an imaging unit 271, a detection unit 272, a transmission unit 273, and a control unit 277 instead of the imaging unit 71, the detection unit 72, the transmission unit 73, and the control unit 77, and the other units are configured similarly to the mobile terminal 13. The mobile terminal 203 transmits the update image selected by the provider to the server 202.

Specifically, the imaging unit 271 images a predetermined region with the current position of the mobile terminal 203 as the imaging position and the current direction of the mobile terminal 203 as the imaging direction. The imaging unit 271 supplies a captured image being captured in real time to the generation unit 75 as a camera view image. The imaging unit 271 supplies a captured image at a predetermined timing to the transmission unit 273 as an evaluation image. The imaging unit 271 supplies a captured image at a predetermined timing to the transmission unit 273 as an update image.

The detection unit 272 is configured similarly to the detection unit 72, and detects the imaging position and the imaging direction of each captured image. The detection unit 272 supplies the imaging information for evaluation and the imaging information for update to the transmission unit 273 on the basis of the detection result, and supplies the camera view imaging information to the generation unit 75.

The transmission unit 273 transmits the evaluation image supplied from the imaging unit 271 and the imaging information for evaluation supplied from the detection unit 272 to the server 202. The transmission unit 273 transmits the update image supplied from the imaging unit 271 and the imaging information for update supplied from the detection unit 272 to the server 202.

The control unit 277 controls each unit of the mobile terminal 203. For example, similarly to the control unit 77 in FIG. 4, the control unit 277 controls the imaging unit 71 and the detection unit 72 to supply the evaluation image and the imaging information for evaluation to the transmission unit 273. The control unit 277 controls the imaging unit 271 and the detection unit 272 on the basis of the operation signal supplied from the input unit 81 to supply the update image selected by the provider and the imaging information for evaluation of the update image to the transmission unit 273. Similarly to the selection of the evaluation image, the selection of the update image is performed by the provider performing a touch operation on the touch panel 76.

### Configuration Example of Evaluation Screen

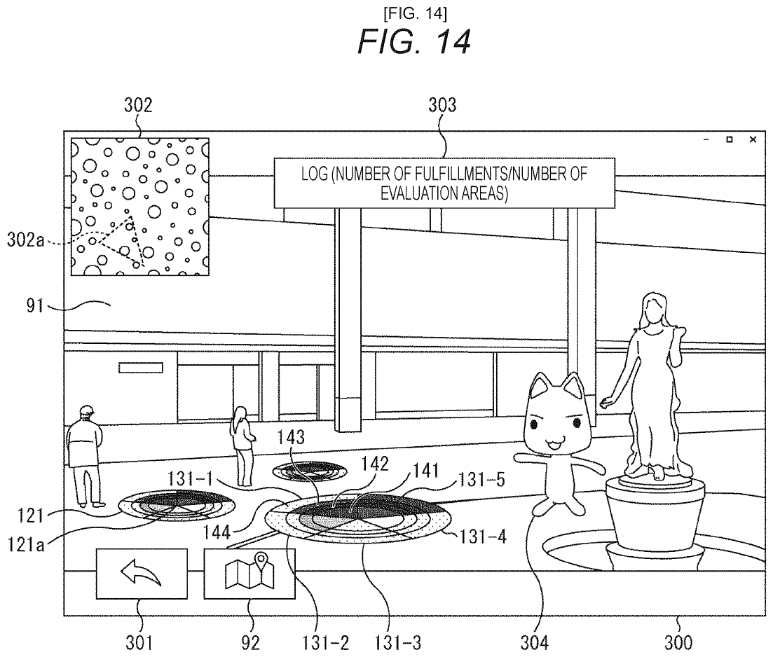

FIG. 14 is a diagram illustrating a configuration example of an evaluation screen displayed on the mobile terminal 203.

In the evaluation screen 300 in FIG. 14, the portions corresponding to the evaluation screen 120 of FIG. 10 are denoted by the same reference signs. Therefore, the description of the portions will be appropriately omitted, and the following description will be provided focusing on portions different from the evaluation screen 120. The evaluation screen 300 is different from the evaluation screen 120 in that the evaluation screen 300 includes an update image button 301, a bird's-eye view 302, a log notification unit 303, and a character 304, and the other units are configured similarly to the evaluation screen 120.

The update image button 301 is touched and operated by the provider in a case where the camera view image 91 is selected as the update image. For example, while viewing the circles 121 displayed on the evaluation screen 300, the provider selects the camera view image 91 as the update image while moving the mobile terminal 203 until the success rate of each circle 121 exceeds a predetermined rate. When the provider performs a touch operation on the update image button 301, the touch operation is received by the input unit 81, and an operation signal indicating the touch operation is supplied to the control unit 277. As a result, under the control of the control unit 277, the camera view image 91 displayed when the provider performs the touch operation is transmitted to the server 12 as the update image. Furthermore, under the control of the control unit 277, the camera view imaging information of the camera view image 91 is transmitted to the server 202 as the imaging information for evaluation.

The bird's-eye view 302 is a bird's-eye view of a grid of the evaluation map. On the bird's-eye view 302, an imaging region 302a representing a region corresponding to the camera view image 91 is displayed.

The log notification unit 303 is a region for notifying the log of the evaluation map. In the example of FIG. 3, the log notification unit 303 displays the number of fulfillments/the number of evaluation areas as information indicating the fulfillment rate of the evaluation map. Here, the number of evaluation areas is the sum of the regions 141 to 144 of all the circles 121. The number of fulfillments is the number of regions 141 to 144 in which data exists, that is, the number of regions 141 to 144 estimated by the corresponding number of times of trial.

The character 304 is, for example, a character used in a video see-through type augmented reality (AR) application in which the provider provides a VPS. By displaying the character 304, the provider can visually recognize the screen actually displayed in the video see-through AR application that provides the VSP.

The bird's-eye view 302, the log notification unit 303, and the character 304 are displayed on the basis of, for example, display control information. That is, the display control information in the third embodiment is information that also displays the bird's-eye view 302, the log notification unit 303, and the character 304.

The bird's-eye view 302, the log notification unit 303, and the character 304 may also be included in the evaluation screen 120 in FIG. 10. The bird's-eye view 302, the log notification unit 303, and the character 304 may not be displayed on the evaluation screen 300.

### Description of Processing by Server

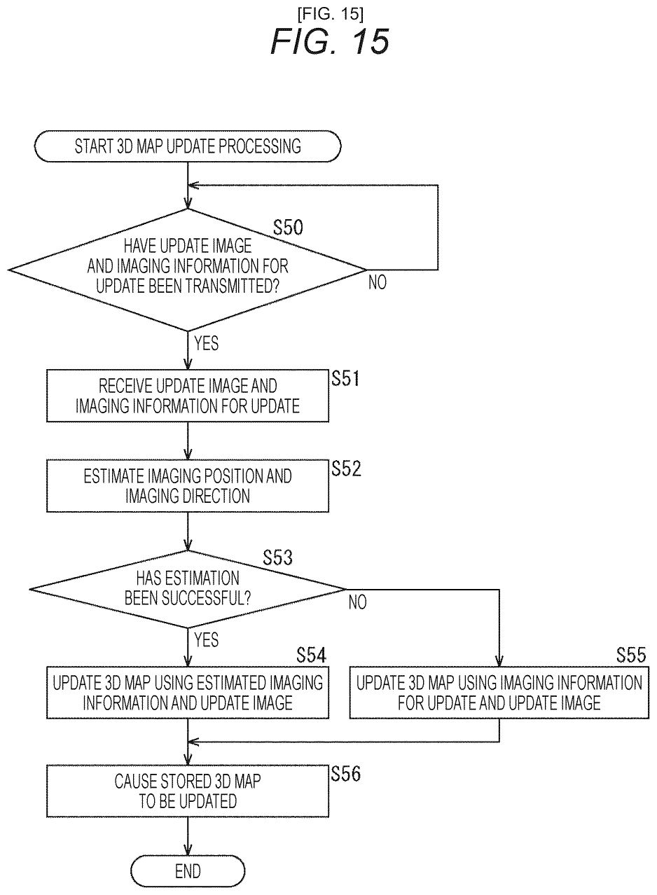

FIG. 15 is a flowchart illustrating 3D map update processing in which the server 202 updates the 3D map.

In step S50 of FIG. 15, the reception unit 221 determines whether or not the update image and the imaging information for update have been transmitted from the mobile terminal 203. In a case where it is determined in step S50 that the update image and the imaging information for update have not been transmitted, the process waits until the update image and the imaging information for update are transmitted.

On the other hand, in a case where it is determined in step S50 that the update image and the imaging information for update have been transmitted, the process proceeds to step S51. In step S51, the reception unit 221 receives the update image and the imaging information for update transmitted from the mobile terminal 203, and supplies the update image and the imaging information for update to the estimation unit 222.

In step S52, the estimation unit 222 estimates the imaging position and the imaging direction of the update image by performing matching between the feature point of the 3D map stored in the 3D map storage unit 53 and the feature point of the update image received by the processing in step S51.

In step S53, the estimation unit 222 determines whether or not the estimation has been successful, similarly to the processing in step S33 in FIG. 8. In a case where it is determined in step S53 that the estimation has been successful, the estimation unit 222 supplies the estimated imaging information and the update image to the 3D map update unit 223, and the process proceeds to step S54.

In step S54, the 3D map update unit 223 reads the 3D map from the 3D map storage unit 224, and updates the 3D map using the estimated imaging information and the update image. Then, the process proceeds to step S56.

On the other hand, in a case where it is determined in step S53 that the estimation has not been successful, that is, in a case where it is determined that the estimation has failed, the estimation unit 222 supplies the imaging information for update and the update image received by the processing in step S51 to the 3D map update unit 223, and the process proceeds to step S55.

In step S55, the 3D map update unit 223 reads the 3D map from the 3D map storage unit 224, and updates the 3D map using the imaging information for update and the update image. Then, the process proceeds to step S56.

In step S56, the 3D map update unit 223 supplies the 3D map updated in step S54 or step S55 to the 3D map storage unit 224 to cause the 3D map storage unit 224 to update the stored 3D map. Then, the process ends.

Note that the evaluation image may be automatically used for updating the 3D map as the update image. Furthermore, the update image may be transmitted from the imaging device 11 instead of being transmitted from the mobile terminal 203.

As described above, similarly to the server 12, the server 202 acquires the evaluation image and the imaging information for evaluation, estimates the imaging position and the imaging direction of the evaluation image, creates the evaluation map, updates the success-or-failure related information corresponding to the estimated imaging information of the evaluation map in a case where the estimation is successful, and updates the success-or-failure related information corresponding to the imaging information for evaluation of the evaluation map in a case where the estimation fails. Therefore, in the case of estimating the imaging position and the imaging direction, it is possible to provide the imaging position and the imaging direction in both the case where the estimation is successful and the case where the estimation fails.

Furthermore, the server 202 creates an evaluation map similarly to the server 110. Therefore, even in a case where the number of times of trial of estimation increases, it is possible to simply provide the range of the imaging position and the range of the imaging direction in both a case where estimation is successful and a case where estimation fails.

Moreover, the server 202 updates the 3D map using the update image. Therefore, the success rate of the estimation of the imaging position and the imaging direction of the evaluation image can be improved.

In the first to third embodiments, the mobile terminal 13 (203) generates the evaluation screen, but the server 12 (202) may generate the evaluation screen. In this case, the mobile terminal 13 (203) transmits the camera view image and the camera view imaging information to the mobile terminal 13 (203).

The success-or-failure related information may be failure rate information indicating a failure rate of estimation, likelihood information indicating a likelihood of an estimation result, matching number information indicating a matching number (matching inlier number), which is the number of feature points matched by the estimation unit 58 (222), or the like. The success-or-failure related information may be information indicating a time average of the likelihood and the matching number rather than the likelihood and the matching number themselves.

In a case where the estimation unit 58 (222) determines the estimation result on the basis of the likelihood for each imaging position and each imaging direction, there is a possibility that a plurality of estimation results having the same likelihood can be obtained. In this case, the evaluation map may be updated on the basis of the plurality of estimation results.

In the third embodiment, in a case where the estimation fails immediately after the update of the 3D map, the regions 141 to 144 corresponding to the evaluation image used for the estimation may be donated with a color, a pattern, or the like indicating that the estimation fails even immediately after the update of the 3D map.

A 3D mesh in the 3D model corresponding to the camera view image 91 may be superimposed on the camera view image 91. In the evaluation screen 90 (120, 300), the success or failure of the estimation for the current evaluation image may be notified by voice.

Although the direction range information and the success rate information are the circles 121 with the position corresponding to each grid as the center 121a, the direction range information and the success rate information may be two-dimensional figures such as hexagons other than circles as long as the ranges of the position and the direction can be represented.

### 4. Grid

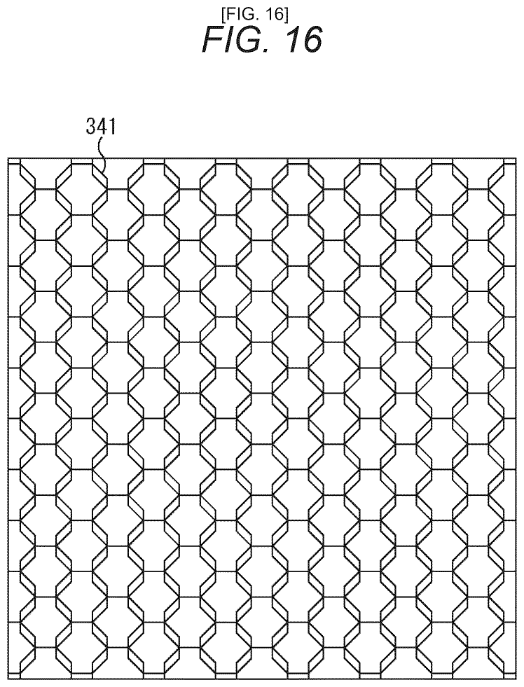

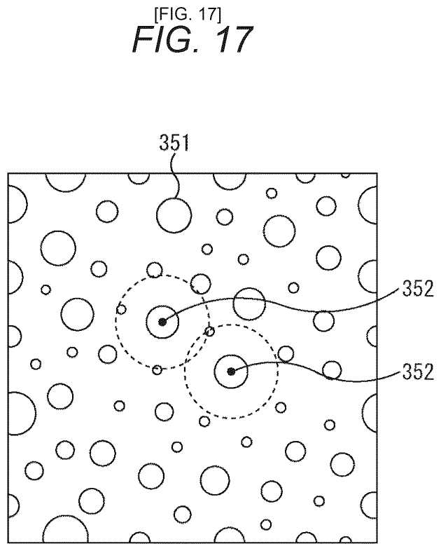

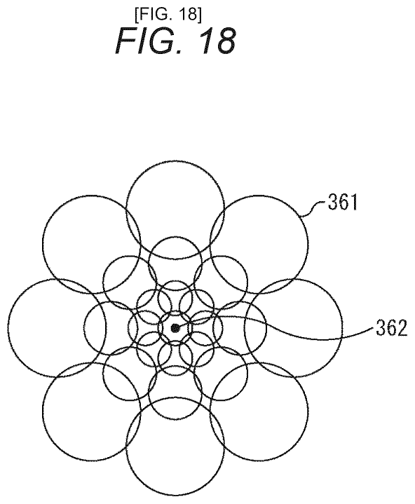

As the shape of the grid formed as the evaluation map in the second and third embodiments, for example, a polygonal grid such as a regular hexagonal grid 341 illustrated in FIG. 16 can be adopted. As illustrated in FIG. 17, a grid 351 may be distributed around a position 352 of each captured image (key frame) used to generate the 3D map. As illustrated in FIG. 18, a grid 361 may be distributed around a position 362 where the character 304 is arranged.

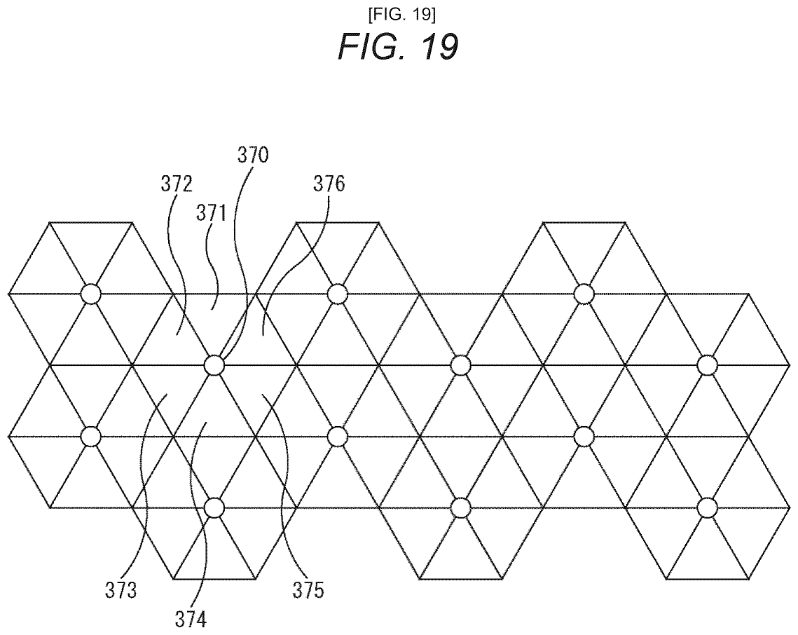

The grid may correspond not only to the imaging position in the predetermined range but also to the imaging direction in the predetermined range. Specifically, for example, in a case where the imaging directions are classified into six ranges of every 60 degrees, as illustrated in FIG. 19, six equilateral triangular grids 371 to 376 having the same vertex 370 correspond to the imaging positions in the same range, and each of the grids 371 to 376 can correspond to the respective ranges of the six imaging directions. In this case, the success-or-failure related information is registered in association with the grid corresponding to the estimated imaging information or the imaging information for evaluation.

### 5. Computer

The above-described series of processing by the server 12 (110, 202) can be executed by hardware or can be executed by software. In a case where a series of processing is executed by software, a program included in the software is installed on a computer. Here, examples of the computer include a computer incorporated in dedicated hardware, and a general-purpose personal computer capable of executing various functions by installing various programs.

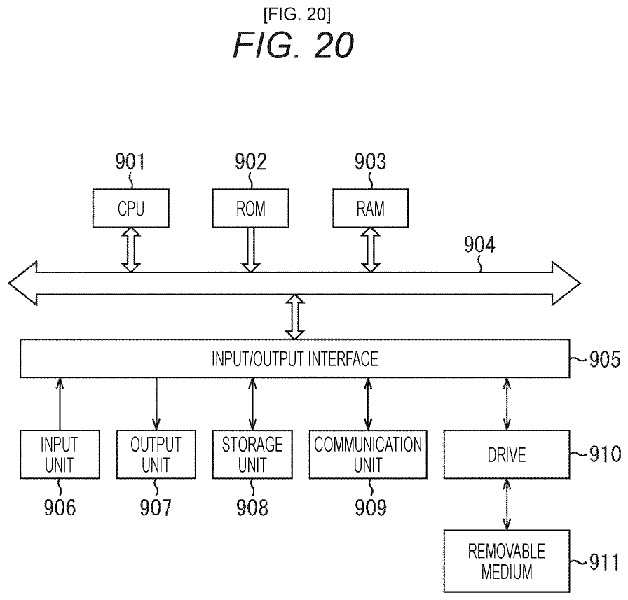

FIG. 20 is a block diagram illustrating a configuration example of hardware of a computer that executes the above-described series of processing by a program.

In the computer, a central processing unit (CPU) 901, a read only memory (ROM) 902, and a random access memory (RAM) 903 are interconnected with a bus 904.

An input/output interface 905 is further connected to the bus 904. An input unit 906, an output unit 907, a storage unit 908, a communication unit 909, and a drive 910 are connected to the input/output interface 905.

The input unit 906 includes a keyboard, a mouse, a microphone, and the like. The output unit 907 includes a display, a speaker and the like. The storage unit 908 includes a hard disk, a non-volatile memory and the like. The communication unit 909 includes a network interface and the like. The drive 910 drives a removable medium 911 such as a magnetic disk, an optical disk, a magneto-optical disk, or a semiconductor memory.

In the computer configured as described above, for example, the CPU 901 loads the program stored in the storage unit 908 into the RAM 903 via the input/output interface 905 and the bus 904 and executes the program, thereby performing the above-described series of processing.

The program executed by the computer (CPU 901) can be provided, for example, by being recorded in the removable medium 911 as a package medium and the like. Furthermore, the program can be provided via a wired or wireless transmission medium such as a local area network, the Internet, or digital satellite broadcasting.

In the computer, the program can be installed in the storage unit 908 via the input/output interface 905 by mounting the removable medium 911 on the drive 910. Furthermore, the program may be received by the communication unit 909 via a wired or wireless transmission medium to be installed on the storage unit 908. In addition, the program may be installed in advance on the ROM 902 and the storage unit 908.

Note that the program executed by the computer may be a program by which processing is performed in time series in the order described in the present specification, or may be a program by which processing is performed in parallel or at necessary timing such as when a call is made.

In the present specification, a system means a set of a plurality of components (devices, modules (parts), and the like), and it does not matter whether or not all the components are in the same housing. Therefore, a plurality of devices housed in separate housings and connected to each other via a network and one device in which a plurality of modules is housed in one housing are both systems.

Embodiments of the present technology are not limited to the above-described embodiments, and various modifications may be made without departing from the gist of the present technology.

For example, it is possible to adopt a mode obtained by combining all or some of the plurality of embodiments described above. Specifically, for example, the success-or-failure related information in the first embodiment may be success rate information or the like similarly to the second embodiment and the third embodiment. The evaluation map in the third embodiment may be configured similarly to the evaluation map in the first embodiment. The success-or-failure related information in the third embodiment may be success-or-failure information similarly to the success-or-failure related information in the first embodiment.

For example, the present technology may be configured as cloud computing in which a function is shared by a plurality of devices via the network to processing together.

Furthermore, each step described in the above flowchart may be executed by one device or shared and executed by a plurality of devices.

Moreover, in a case where a plurality of pieces of processing is included in one step, the plurality of pieces of processing included in the one step can be executed by one device or shared and executed by a plurality of devices.

The effects described in the present specification are merely examples and are not limited, and there may be other effects.

The present technology can have the following configurations.

(1) An information processing device including: an acquisition unit that acquires an evaluation image captured by an imaging device and imaging information for evaluation that is imaging information indicating an imaging position and an imaging direction of the evaluation image;

an estimation unit that estimates the imaging position and the imaging direction of the evaluation image by performing matching between a feature point of a 3D map and a feature point of the evaluation image acquired by the acquisition unit;

a creation unit that creates an evaluation map that registers success-or-failure related information related to whether or not the estimation by the estimation unit has succeeded in association with the imaging position and the imaging direction of the evaluation image; and

an evaluation map update unit that updates the success-or-failure related information corresponding to the imaging position and the imaging direction estimated by the estimation unit in a case where the estimation by the estimation unit has succeeded, and updates the success-or-failure related information corresponding to the imaging position and the imaging direction indicated by the imaging information for evaluation in a case where the estimation by the estimation unit has failed.

(2) The information processing device according (1), further including:

a generation unit that generates, on the basis of the evaluation map, display control information for displaying, at the imaging position registered in the evaluation map on the evaluation image acquired by the acquisition unit, direction information indicating the imaging direction registered in the evaluation map in association with the imaging position, and the success-or-failure related information; and

a transmission unit that transmits the display control information to the imaging device.

(3) The information processing device according to (2),

in which the display control information is information that also displays information indicating a fulfillment rate of the evaluation map.

(4) The information processing device according to any one of (1) to (3),

in which the success-or-failure related information is success-or-failure information indicating whether or not the estimation by the estimation unit has been successful.

(5) The information processing device according to any one of (1) to (3),

in which the success-or-failure related information is information indicating a success rate or a failure rate of the estimation by the estimation unit.

(6) The information processing device according to (5),

in which the success-or-failure related information is information indicating the success rate or the failure rate for each number of times of trial of the estimation by the estimation unit or for each time after the estimation has succeeded.

(7) The information processing device according to (5),

in which the success-or-failure related information is information indicating the success rate or the failure rate for each height or pitch of the imaging device.

(8) The information processing device according to any one of (1) to (3),

in which the success-or-failure related information is likelihood information indicating likelihood of a result of the estimation by the estimation unit.

(9) The information processing device according to any one of (1) to (3),

in which the success-or-failure related information is matching number information indicating a matching number, the matching number being the number of the feature points matched by the estimation unit.

(10) The information processing device according to any one of (1) to (9),

in which the creation unit is configured to create the evaluation map in which direction range information and the success-or-failure related information are registered in association with each grid by forming a plurality of grids on the 3D map, the direction range information indicating a range of the imaging direction of the evaluation image in which the imaging position exists in a region corresponding to each grid.

(11) The information processing device according to (10),

in which the creation unit is configured to create the plurality of grids in a ground region of the 3D map.

(12) The information processing device according to (11), further including

a detection unit that detects the ground region from the 3D map,

in which the creation unit is configured to create the plurality of grids in the ground region detected by the detection unit.

(13) The information processing device according to any one of (1) to (12), further including

a 3D map update unit that updates the 3D map using an update image that is an image for updating the 3D map,

in which the acquisition unit is configured to acquire the update image and imaging information for update indicating an imaging position and an imaging direction of the update image,

the estimation unit is configured to estimate the imaging position and the imaging direction of the update image by performing matching between the feature point of the 3D map and the feature point of the update image, and

the 3D map update unit is configured to update the 3D map using the update image, and the imaging position and the imaging direction estimated by the estimation unit or the imaging information for update.

(14) An information processing method performed by an information processing device, the information processing method including:

an acquisition step acquiring an evaluation image captured by an imaging device and imaging information for evaluation that is imaging information indicating an imaging position and an imaging direction of the evaluation image;

an estimation step of estimating the imaging position and the imaging direction of the evaluation image by performing matching between a feature point of a 3D map and a feature point of the evaluation image acquired by the acquisition step;

a creation step of creating an evaluation map in which success-or-failure related information regarding whether or not the estimation by the estimation step has been successful is registered in association with the imaging position and the imaging direction of the evaluation image; and

an evaluation map update step of updating the success-or-failure related information corresponding to the imaging position and the imaging direction estimated by the estimation step in a case where the estimation by the estimation step is successful, and updating the success-or-failure related information corresponding to the imaging position and the imaging direction indicated by the imaging information for evaluation in a case where the estimation by the estimation step fails.

(15) A program for causing a computer to function as an information processing device, the information processing device including:

an acquisition unit that acquires an evaluation image captured by an imaging device and imaging information for evaluation that is imaging information indicating an imaging position and an imaging direction of the evaluation image;

an estimation unit that estimates the imaging position and the imaging direction of the evaluation image by performing matching between a feature point of a 3D map and a feature point of the evaluation image acquired by the acquisition unit;

a creation unit that creates an evaluation map in which success-or-failure related information regarding whether or not the estimation by the estimation unit has been successful is registered in association with the imaging position and the imaging direction of the evaluation image; and

an evaluation map update unit that updates the success-or-failure related information corresponding to the imaging position and the imaging direction estimated by the estimation unit in a case where the estimation by the estimation unit is successful, and updates the success-or-failure related information corresponding to the imaging position and the imaging direction indicated by the imaging information for evaluation in a case where the estimation by the estimation unit fails.

### REFERENCE SIGNS LIST

12 Server
13 Mobile terminal
54 Detection unit
55 Evaluation map creation unit
57 Reception unit
58 Estimation unit
59 Evaluation map update unit
60 Generation unit
61 Transmission unit
91a to 91c View cone
110 Server
111 Evaluation map creation unit
112 Evaluation map update unit
113 Generation unit
121 Circle
202 Server
203 Mobile terminal
221 Reception unit
222 Estimation unit
303 Log notification unit

1. An information processing device comprising:
an acquisition unit that acquires an evaluation image captured by an imaging device and imaging information for evaluation that is imaging information indicating an imaging position and an imaging direction of the evaluation image;
an estimation unit that estimates the imaging position and the imaging direction of the evaluation image by performing matching between a feature point of a 3D map and a feature point of the evaluation image acquired by the acquisition unit;
a creation unit that creates an evaluation map in which success-or-failure related information regarding whether or not the estimation by the estimation unit has been successful is registered in association with the imaging position and the imaging direction of the evaluation image; and
an evaluation map update unit that updates the success-or-failure related information corresponding to the imaging position and the imaging direction estimated by the estimation unit in a case where the estimation by the estimation unit is successful, and updates the success-or-failure related information corresponding to the imaging position and the imaging direction indicated by the imaging information for evaluation in a case where the estimation by the estimation unit fails.

2. The information processing device according to claim 1, further comprising:
a generation unit that generates, on a basis of the evaluation map, display control information for displaying, at the imaging position registered in the evaluation map on the evaluation image acquired by the acquisition unit, direction information indicating the imaging direction registered in the evaluation map in association with the imaging position, and the success-or-failure related information; and
a transmission unit that transmits the display control information to the imaging device.

3. The information processing device according to claim 2,
wherein the display control information is information that also displays information indicating a fulfillment rate of the evaluation map.

4. The information processing device according to claim 1,
wherein the success-or-failure related information is success-or-failure information indicating whether or not the estimation by the estimation unit has been successful.

5. The information processing device according to claim 1,
wherein the success-or-failure related information is information indicating a success rate or a failure rate of the estimation by the estimation unit.

6. The information processing device according to claim 5,
wherein the success-or-failure related information is information indicating the success rate or the failure rate for each number of times of trial of the estimation by the estimation unit or for each time after the estimation is successful.

7. The information processing device according to claim 5,
wherein the success-or-failure related information is information indicating the success rate or the failure rate for each height or pitch of the imaging device.

8. The information processing device according to claim 1,
wherein the success-or-failure related information is likelihood information indicating likelihood of a result of the estimation by the estimation unit.

9. The information processing device according to claim 1,
wherein the success-or-failure related information is matching number information indicating a matching number, the matching number being the number of the feature points matched by the estimation unit.

10. The information processing device according to claim 1,
wherein the creation unit is configured to create the evaluation map in which direction range information and the success-or-failure related information are registered in association with each grid by forming a plurality of grids on the 3D map, the direction range information indicating a range of the imaging direction of the evaluation image in which the imaging position exists in a region corresponding to each grid.

11. The information processing device according to claim 10,
wherein the creation unit is configured to create the plurality of grids in a ground region of the 3D map.

12. The information processing device according to claim 11, further comprising
a detection unit that detects the ground region from the 3D map,
wherein the creation unit is configured to create the plurality of grids in the ground region detected by the detection unit.

13. The information processing device according to claim 1, further comprising
a 3D map update unit that updates the 3D map using an update image that is an image for updating the 3D map,
wherein the acquisition unit is configured to acquire the update image and imaging information for update indicating an imaging position and an imaging direction of the update image,
the estimation unit is configured to estimate the imaging position and the imaging direction of the update image by performing matching between the feature point of the 3D map and the feature point of the update image, and
the 3D map update unit is configured to update the 3D map using the update image, and the imaging position and the imaging direction estimated by the estimation unit or the imaging information for update.

14. An information processing method performed by an information processing device, the information processing method comprising:
an acquisition step acquiring an evaluation image captured by an imaging device and imaging information for evaluation that is imaging information indicating an imaging position and an imaging direction of the evaluation image;
an estimation step of estimating the imaging position and the imaging direction of the evaluation image by performing matching between a feature point of a 3D map and a feature point of the evaluation image acquired by the acquisition step;
a creation step of creating an evaluation map in which success-or-failure related information regarding whether or not the estimation by the estimation step has been successful is registered in association with the imaging position and the imaging direction of the evaluation image; and
an evaluation map update step of updating the success-or-failure related information corresponding to the imaging position and the imaging direction estimated by the estimation step in a case where the estimation by the estimation step is successful, and updating the success-or-failure related information corresponding to the imaging position and the imaging direction indicated by the imaging information for evaluation in a case where the estimation by the estimation step fails.

15. A program for causing a computer to function as an information processing device, the information processing device comprising:
an acquisition unit that acquires an evaluation image captured by an imaging device and imaging information for evaluation that is imaging information indicating an imaging position and an imaging direction of the evaluation image;
an estimation unit that estimates the imaging position and the imaging direction of the evaluation image by performing matching between a feature point of a 3D map and a feature point of the evaluation image acquired by the acquisition unit;
a creation unit that creates an evaluation map in which success-or-failure related information regarding whether or not the estimation by the estimation unit has been successful is registered in association with the imaging position and the imaging direction of the evaluation image; and
an evaluation map update unit that updates the success-or-failure related information corresponding to the imaging position and the imaging direction estimated by the estimation unit in a case where the estimation by the estimation unit is successful, and updates the success-or-failure related information corresponding to the imaging position and the imaging direction indicated by the imaging information for evaluation in a case where the estimation by the estimation unit fails.
